(19) United States
(12) Patent Application Publication
(10) Pub. No.: US 2018/0292325 A1
(43) Pub. Date: Oct. 11, 2018

(54) SYSTEMS AND METHODS FOR OPTOCHEMICAL IMAGING OF A CHEMICALLY ACTIVE SURFACE

(71) Applicant: CASE WESTERN RESERVE UNIVERSITY, Cleveland, OH (US)

(72) Inventors: Miklos Gratzl, Cleveland Heights, OH (US); Punkaj Ahuja, Cleveland, OH (US); Brian Hemphill, Cleveland, OH (US)

(21) Appl. No.: 15/577,981

(22) PCT Filed: Jun. 23, 2016
(86) PCT No.: PCT/US2016/039000

§ 371 Date: Nov. 29, 2017

Related U.S. Application Data
(60) Provisional application No. 62/183,396, filed on Jun. 23, 2015.

(51) Int. Cl. G01N 21/80

(52) U.S. Cl. CPC G01N 21/80; G01N 2021/775

(57) ABSTRACT

The present disclose generally relates to optochemical imaging of a chemically active surface. A system that can facilitate such optochemical imaging can include an analyte-permeable membrane configured to prevent diffusion of outside contaminates into the system. The analyte permeable membrane comprising: a first surface; and a second surface opposed to the first surface configured to contact a chemically-active surface to permit diffusion of an analyte into the system from the chemically-active surface. The system also includes a measurement component coupled to the analyte-permeable membrane and configured to interact with the analyte. The interaction between the analyte and the measurement component causes a detectable change of a property of the measurement component.

### CROSS-REFERENCE TO RELATED APPLICATIONS

This application claims the benefit of U.S. Provisional Application No. 62/183,396, filed Jun. 23, 2015, entitled “Functional Imaging of Chemically Active Surfaces with Optical Reporter Microbeads.” This application is hereby incorporated by reference in its entirety for all purposes.

### TECHNICAL FIELD

The present disclosure relates generally to optochemical imaging and, more specifically, to systems and methods for optochemical imaging of a chemically active surface.

### BACKGROUND

Scanning probe microscopy (SPM) is an imaging technique that forms images of a surface using a physical probe that scans a region of interest on the surface. Current approaches to imaging concentration fields at surfaces include different modalities of SPM. For example, scanning electrochemical microscopy (SECM) is a technique within the broader class of SPM that is employs a scanning tip to measure the local electrochemical behavior at probe positions over the surface within the region of interest, which can be used to obtain a continuous map. Indeed, SECM has been utilized for a wide variety of applications including chemical analysis of biological processes at single cells and cell monolayers as well as at 3D constructs. However, scanning probe techniques are limited, in that the time needed to complete a scan can be longer than what the dynamics of the studied process would ideally require, and the moving tip can potentially induce microflow especially at faster scan rates. Additionally, fluorescence confocal laser scanning microscopy can also be used to visualize pH or concentration profiles, but is limited to being able to access very small regions of interest.

Another approach is nanometer scale Photonic Explorers for Biomedical use with Biologically Localized Embedding (PEBBLEs) for chemical measurements in single cells and multicellular constructs. PEBBLEs, delivered into cells by non-specific endocytosis, addresses several of the limitations associated with conventional ‘free’ intracellular fluorescent dyes. PEBBLEs, however, have not been used in extracellular contexts such as in studies on cellular secretions because of technical limitations: many particles would float away from the cells' surface while others would non-specifically endocytose.

### SUMMARY

The present disclosure relates generally to optochemical imaging and, more specifically, to systems and methods for optochemical imaging of a chemically active surface.

In one aspect, the present disclosure can include a system for optochemical imaging. The system includes a sensor that includes an analyte-permeable membrane configured to prevent diffusion of outside contaminates into the system. The analyte permeable membrane can include a first surface; and a second surface opposed to the first surface configured to contact a chemically-active surface to permit diffusion of an analyte into the system from the chemically-active surface. The sensor can also include a measurement component coupled to the analyte-permeable membrane and configured to interact with the analyte. The interaction between the analyte and the measurement component causes a detectable change of a property of the measurement component.

In another aspect, the present disclosure can include a method for optochemical imaging. The method can include placing a sensing mechanism onto a chemically-active surface. The sensing mechanism comprises an analyte-permeable membrane configured to prevent diffusion of outside contaminates into the system, the analyte permeable membrane while permitting diffusion of an analyte into the sensing mechanism and a measurement component coupled to the analyte-permeable membrane and configured to interact with the analyte. The method also includes changing of a property of the measurement component based on an interaction between the measurement component and the analyte. The change of the property of the measurement component correlates to a property of the analyte.

### BRIEF DESCRIPTION OF THE DRAWINGS

The foregoing and other features of the present disclosure will become apparent to those skilled in the art to which the present disclosure relates upon reading the following description with reference to the accompanying drawings, in which:

FIG. 1 is a schematic diagram showing a system that facilitates optochemical imaging of a chemically active surface in accordance with an aspect of the present disclosure;

FIGS. 2-4 each show schematic diagrams of the system in FIG. 1 with additional components;

FIG. 4 is a process flow diagram illustrating a method for providing blood pressure control through feedback based neural stimulation according to another aspect of the present disclosure;

FIG. 5 is a process flow diagram illustrating a method for optochemical imaging of a chemically active surface in accordance with another aspect of the present disclosure;

FIG. 6 is a schematic diagram of a setup for microbead-based optochemical imaging of pH diffusion above an inert substrate;

FIG. 7 is a graph used for calibration of pH sensitive optode beads;

FIG. 8 shows images of propagation of base from a pore 205 μm (n=10) imaged at the substrate in free space and in a laterally confined space;

FIG. 9 shows continuous color maps of lateral base propagation from a pore 165 μm in diameter (n=10) over time in lateral pH propagation at the substrate; and

FIG. 10 is a graph showing the distance of the pH 6.5 circle from a pore 165 μm in diameter (n=10) over time in lateral pH propagation at the substrate.

### DETAILED DESCRIPTION

### I. Definitions

Unless defined otherwise, all technical and scientific terms used herein have the same meaning as is commonly understood by one of skill in the art to which the present disclosure pertains.

In the context of the present disclosure, the singular forms “a,” “an” and “the” can also include the plural forms, unless the context clearly indicates otherwise.

The terms “comprises” and/or “comprising,” as used herein, can specify the presence of stated features, steps, operations, elements, and/or components, but do not preclude the presence or addition of one or more other features, steps, operations, elements, components, and/or groups.

As used herein, the term “and/or” can include any and all combinations of one or more of the associated listed items.

Additionally, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present disclosure.

The sequence of operations (or acts/steps) is not limited to the order presented in the claims or figures unless specifically indicated otherwise.

As used herein, the term “optochemical” when used with the term sensor refers to the transduction of a chemical or biological event to an optical signal.

As used herein, the term “optode”, or “optrode”, can refer to at least a portion of a sensor device that can undergo an optical change in the presence of an analyte. For example, the optical change can be a detectable change in an optical characteristic. In some instances, the optical change (e.g., a color change) can be qualitatively perceived or quantitatively detected. In some instances, optodes can be in the form of one or more optode beads and/or one or more optode membranes. As an example, the optode can be made with sensitivity to different ionic species and other analytes including sodium, potassium, ammonia, sulfur dioxide, hydrogen sulfide, ethanol, acetone, oxygen, carbon dioxide, metabolites such as glucose, or the like.

As used herein, the term “analyte” can refer to a chemical substance or a biological substance that is the subject of a chemical analysis. In some instances, the analyte can be present on a chemically active surface. In other instances, the analyte can be a reaction product (e.g., a reaction product of an enzymatic reaction). For example, the analyte can be a chemical or a biological/physiological product.

As used herein, the term “surface” can refer to an outside part of an object. One non-limiting example surface can include a subject's skin. Another non-limiting example surface can include an exterior portion of an object.

As used herein, the term “chemically active”, when used to describe a surface, can refer to a surface of an object that can include an analyte of interest or a reaction product of the analyte of interest thereon. For example, a chemically active surface can include a subject's skin, and an analyte can be located within the interstitial fluid beneath the skin surface.

As used herein, the term “qualitative” can refer to a quality that can be perceived by the naked eye. For example, the results of a qualitative measurement (or qualitative perception) can include a description and/or observation.

As used herein, the term “quantitative” can refer to a quantity that can be measured. For example, the results of a quantitative measurement can include numerical data.

As used herein, the terms “subject” and “patient” can be used interchangeably and refer to any warm-blooded organism including, but not limited to, a human being, a pig, a rat, a mouse, a dog, a cat, a goat, a sheep, a horse, a monkey, an ape, a rabbit, a cow, etc. For example, the multichannel ultra-low noise amplifier can be used in the collection of biological recordings from a subject.

### II. Overview

The present disclosure relates generally to optochemical imaging and, more specifically, to systems and methods for optochemical imaging of a chemically active surface. The optochemical imaging can be facilitated by a measurement component, at least a portion of which undergoes a detectable change in an optical characteristic in the presence of an analyte (e.g., oxygen, protons (pH), sodium, potassium, glucose, or the like). For example, the measurement component can include one or more optodes, chemical sensors that respond to the presence of the analyte with a detectable change in an optical characteristic. The detectable change in the optical characteristic can be qualitatively perceived or quantitatively detected using optochemical imaging.

Such optochemical imaging can be used to provide functional imaging of the chemically active surface. Optochemical imaging has features in common with traditional modalities, like scanning probe microscopy as well as PEBBLEs, including the ability to report concentrations at specific locations on a studied surface to form a concentration profile. However, optochemical imaging is superior to traditional modalities in that it enables the acquisition of a chemical image of the entire region of interest, which can be larger than with other imaging modalities, instantaneously while eliminating the possibility for microflow that could distort the concentration field. Optochemical imaging is further distinguishable from traditional modalities in that while the post-processing that is required is more complicated, recording from a greater number of data points to increase the resolution of the concentration profile requires only additional capabilities of the measurement component. Additionally, the measurement component can encode concentration to fluorescence intensity or color, whose calibration is more robust than intensity because color is determined on a spectrum, which does not depend on intensity of illumination or on the thickness of the optically active region.

### III. Systems

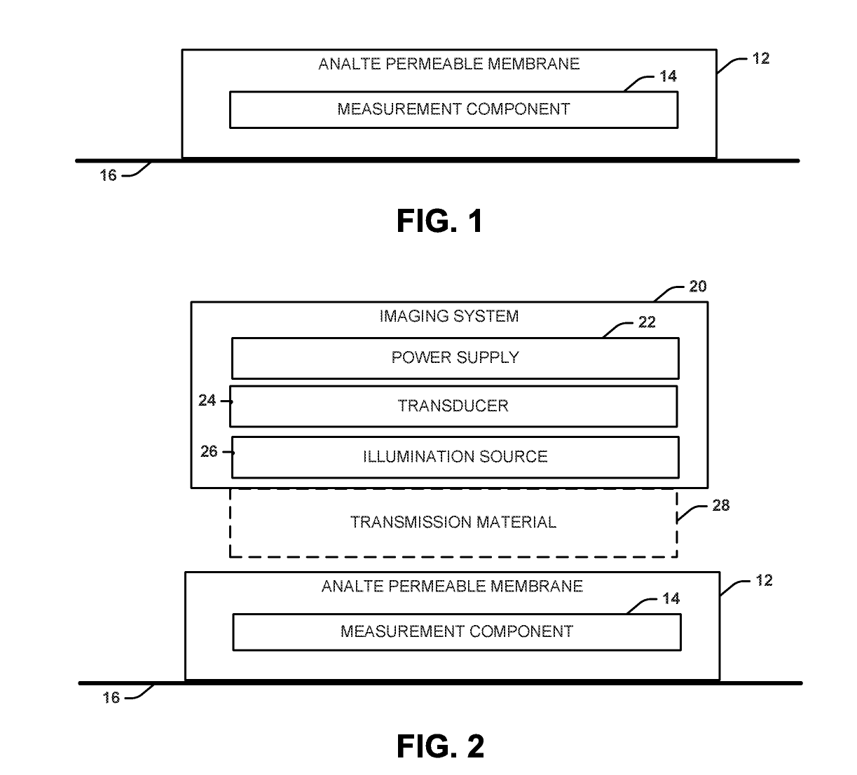

One aspect of the present disclosure can include a system (FIG. 1) that can facilitate optochemical imaging using a sensor. The sensor, in its simplest form, can include an analyte permeable membrane 12 coupled to a measurement component 14, a portion of which can undergo an optical change indicating the presence or a property of a certain analyte on a chemically-active surface 16.

Advantageously, the sensor can contact the chemically-active surface 16 and facilitate detection of an analyte. For example, the analyte can be a biochemical species within a physiological sample, water, a soil sample, an agricultural sample, etc. Advantageously, the sensor can be placed on a chemically-active surface 16 for functional imaging (e.g., in the presence of an analyte) of a region of interest thereon. Using optochemical imaging, a chemical image of an entire region of interest can be achieved instantaneously, making optochemical imaging superior to traditional techniques. Additionally, by using optochemical imaging, distortion of the concentration field can be eliminated.

The analyte-permeable membrane 12 can have a first surface and a second surface opposed to the first surface. Accordingly, the analyte-permeable membrane 12 can have a thickness from 10 mm to 500 mm. As one example, the analyte-permeable membrane 12 can have a thickness from 50 mm to 250 mm. In another example, the analyte permeable membrane can have a thickness from 75 mm to 125 mm. However, other ranges of thicknesses are possible. For example, the analyte-permeable membrane 12 can include a hydrogel that can take in water to increase its thickness.

The second surface of the analyte-permeable membrane 12 can be configured to contact a chemically-active surface 16. In some instances, the second surface of the analyte-permeable membrane 12 can be secured to the chemically-active surface. The securing is used, for example, to prevent unwanted movement of the sensor. For example, at least a portion of the second surface of the analyte-permeable membrane can include an adhesive mechanism to facilitate securing the analyte-permeable membrane to a certain location on the chemically-active surface 16.

The analyte-permeable membrane 12 can be semi-permeable or selectively permeable to one or more chemicals (e.g., the analyte or a reaction product of the analyte) on the chemically-active surface 16. In other words, the analyte-permeable membrane 12 can permit diffusion of a certain analyte into the sensor, while restricting or preventing diffusion of outside contaminates into the system (so that the analyte-permeable membrane 12 can be both functional and protective). At least a portion of the measurement component 14, which can be coupled to the analyte-permeable membrane, can undergo a detectable change to a property in the presence of the analyte. For example, the detectable change can be an electrochemical change, a fluorescence change, a luminescence change, a change in absorption, a conductometric change, and a coulometric change. In some instances, the detectable change can be reversible so that the sensor can be reused. Moreover, the detectable change can occur without requiring wires for operation of the sensor, providing a visible alternative to electrodes and other traditional sensors for detecting the analyte in many different applications.

The analyte-permeable membrane 12 can encapsulate the measurement component 14. In other words, the analyte-permeable membrane 12 can cover at least a portion of one side of the measurement component 14. However, more preferably, the analyte-permeable membrane 12 can cover 50% or more of the measurement component 14. In other instances, the analyte-permeable membrane 12 can encapsulate the entire measurement component 14.

In some instances, the measurement component 14 can include an optode material. The optode material can undergo an optical change in the presence of the analyte that does not depend on any binding equilibrium. Rather, the optical change can be based on a charge balance between ions that are taken up or released by one or more optodes. The optode material can be embodied as one or more optode membranes coupled to or within the analyte-permeable membrane 12, for example. As another example, the optode material can be embodied as a plurality of optode beads (e.g., microbeads) dispersed within at least a portion of the analyte-permeable membrane 12.

In some instances, the measurement component 14 can include one or more indicator materials that undergo a chemical or physical change in response to the analyte or to a reaction product of the analyte. The indicator material may be a pH sensitive material (e.g., a dye) that is responsive to a pH change induced by an analyte or, more commonly, a detectable product by producing a color change (i.e., a change in the absorption wavelength, which may include wavelengths outside the visible range, such as in the IR range), fluorescence, or the like. The color change is reversible, depending upon the concentration of the analyte(s). Exemplary indicator materials, such as dyes, can include Congo red, neutral red, phenol red, methyl red, lacmoid, tetrabromophenolphthalein, α-naphtholphenol, and the like. A dye may be dissolved in organic solvent, such as (NPOE (2-nitrophenyl octyl ether), BEHS (bis(2-ethylhexyl)sebacate), DBE (dibenzyl ether), DOP (dioctyl phthalate), or the like.

In one example, the indicator material can include a light-absorbing, pH-sensitive dye that undergoes a color change in response to an analyte or a reaction product of the analyte. For instance, the indicator material can include a dye that is sensitive to hydrogen ions (i.e., pH) and is reversible (i.e., returns to its previous color when the pH returns to its previous level). Examples of pH-sensitive dyes can generally include ionophores, lipophilic anions, and lipophilic hydrogen ion sensitive dyes (also referred to herein as a chromoionophores). It will be appreciated that where ions other than hydrogen are to be detected, other dyes may be used. In such an arrangement, the ionophore can extract the ion to be detected and the lipophilic hydrogen sensitive dye can exhibit a corresponding color change.

Examples of chromoionophores can include one or more of:
chromoionophore I (9-(diethylamino)-5-(octadecanoylimino)-5H-benzo[a]phenoxazine), designated ETH5249;
chromoionophore II (9-dimethylamino-5-[4-(16-butyl-2,14-dioxo-3,15 ioxaeicosyl)phenylimino] benzo[a] phenoxazine), designated ETH2439;
chromionophore III (9-(diethylamino)-5-[(2-octyldecyl)imino]benzo[a]phenoxazine), designated ETH 5350;
chromoionophore IV (5-octadecanoyloxy-2-(4-nitrophenylazo)phenol), designated ETH2412;
chromoionophore V (9-(diethylamino)-5-(2-naphthoylimino)-5H-benzo[a]phenoxazine);
chromoionophore VI (4′,5′-dibromofluorescein octadecyl ester), designated ETH7075;
chromoionophore XI (fluorescein octadecyl ester), designated ETH7061; and combinations thereof (note that ETF is the designation of the Swiss Federal Institute of Technology).

Examples of lipophilic anions can include KTpCIPB (potassium tetrakis(4-chlorophenyl)borate), NaHFPB (sodium tetrakis[3,5-bis(1,1,3,3,3-hexafluoro-2-methoxy-2-propyl)phenyl]borate), sodium tetrakis[3,5-bis(trifluoromethyl)phenyl]borate, sodium tetrakis(4-fluorophenyl)borate, combinations thereof, and the like.

Examples of ionophores can include sodium ionophores, potassium ionophores, calcium ionophores, and the like. Examples of sodium ionophores can include:
bis[(12-crown-4)methyl]2-dodecyl-2-methylmalonate, designated ETH227;
N,N′,N″-triheptyl-N,N′,N″-trimethyl4,4′,4″-propylidynetris(3-oxabutyramide), designated ETH157;
N,N′-dibenzyl-N,N′-diphenyl-1,2-phenylenedioxydiacetamide, designated ETH2120;
N,N,N′,N′-tetracyclohexyl-1,2-phenylenedioxydiacetamide, designated ETH4120;
4-octadecanoyloxymethyl-N,N,N′,N′-tetracyclohexyl-1,2-phenylenedioxydiacetamide), designated DD-16-C-5;
2,3:11,12-didecalino-16-crown-5), bis(benzo-15-crown-5); and combinations thereof.

Examples of potassium ionophores can include:
bis[(benzo-15-crown-5)-4′-methyl]pimelate, designated BME 44;
2-dodecyl-2-methyl-1,3-propanedil bis[N-{5′-nitro(benzo-15-crown-5)-4′-yl]carbamate], designated ETH1001; and combinations thereof.

Examples of calcium ionophores can include:
(−)-(R,R)—N,N′-bis-[11-(ethoxycarbonyl)undecyl]-N,N′-4,5-tetramethyl-3,6-dioxaoctane-diamide), designated ETH129;
N,N,N′,N′-tetracyclohexyl-3-oxapentanediamide, designated ETH5234; N,N-dicyclohexyl-N′,N′-dioctadecyl-3-oxapentanediamide), designated K23E1;
10,19-bis[(octadecylcarbamoyl)methoxyacetyl]-1,4,7,13,16-pentaoxa-10,19-diazacycloheneicosane); and combinations thereof.

In one example, the measurement component 14 can have the following composition: about 50 mmol of chromoionophore ETH5350 (L); about 360 mmol sodium ionophore Na IV (I); about 55 mmol NaHFPB; and about 0.65 polyvinylchloride:bis(2-ethylhexyl)sebacate. In this case, the equilibrium of such an measurement component 14 can be represented by the following equation:

L^{(m)}+INa^{+(m)}+H⁺↔LH^{+(m)}+I^{(m)}+Na^{+(aq)}.

Additionally, the measurement component 14 can include one or more detection materials that can react with the analyte or catalyze a reaction of the analyte to produce a detectable reaction product. Or, the reaction/catalysis can result in an intermediate reaction product that undergoes further reaction/catalysis with a second or subsequent detection material to form a detectable product. For example, a first detection material can react with or catalyze the reaction of the analyte to produce an intermediate reaction product. A second detection material can then react with or catalyze the reaction of the intermediate reaction product to produce a detectable product. For example, the detection materials can include an enzyme catalyst. The enzymes glucose oxidase or glucose dehydrogenase may be used for the detection of glucose, the enzyme lactase may be used for detection of lactose, the enzyme galactose oxidase may be used for the detection of galactose, the enzyme urate oxidase may be used for the detection of uric acid, and the enzyme creatinine amidhydrogenase may be used for the detection of creatinine.

In an example, the measurement component 14 can be configured to detect the presence and/or concentration of glucose. The measurement component 14 (or the sensor as a whole) can generally comprise, for example, a plasticized polymer, a chromoionophore, an ionophore, and a lipophilic anion. The measurement component 14 can further comprise an enzyme-loaded membrane, such as a glucose oxidase-loaded membrane. In the glucose oxidase-loaded membrane, the following enzyme reaction can occur:

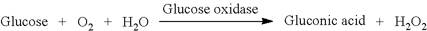

Because the above enzyme reaction produces gluconic acid, the pH in the measurement component 14 changes with changing concentration of glucose. The color (i.e., the absorption spectrum) of the pH indicator dye present in or on the enzyme-loaded membrane or the measurement component 14 will change due to the pH change in the membrane(s). It is this change in the spectrum that is detected and used to determine glucose concentration. Advantageously, such a glucose sensing system can detect glucose in the hypoglycemic range (e.g., below about 60 mg/dl).

Referring now to FIG. 2, illustrated is an imaging system 20 that can be used with the sensor to facilitate detection of the detectable change of the property of the measurement component 14 in the presence of the analyte. The imaging system can have or can be coupled to a device that has a non-transitory memory and a processor for executing operations that facilitate the detection, analysis, or the generation of visualization.

The imaging system 20 can include a power supply 22, an illumination source 26 (coupled to the power supply), and a transducer 24. The illumination source 26 can transmit light to the sensor and the transducer 24 can receive reflected light, which can be used to determine the detectable change in the portion of the measurement component 14 of the sensor. As one example, the illumination source 26 can be a light emitting diode (e.g., an organic light emitting diode) and the transducer includes at least one photodiode. The power source can include, for example, an energy harvesting device (EHD). In some instances, the imaging system 20 can include a transmission material 28 (e.g., a fiber optic material or a fiber optic cable) to transmit the light signal and receive the reflected signal. In some instances, at least a portion of the imaging system 20 can include a mobile device that can display a visualization illustrating the detectable change of the property of the measurement component (which correlates to the presence of the analyte according to a calibration). However, in other instances, the imaging system 20 can include any mechanism configured to communicate an indication related to the detectable change of the property of the measurement component to an end user. For example, the mechanism can include one of a local active display, a remote monitoring system, or any other local or remote monitoring or display system.

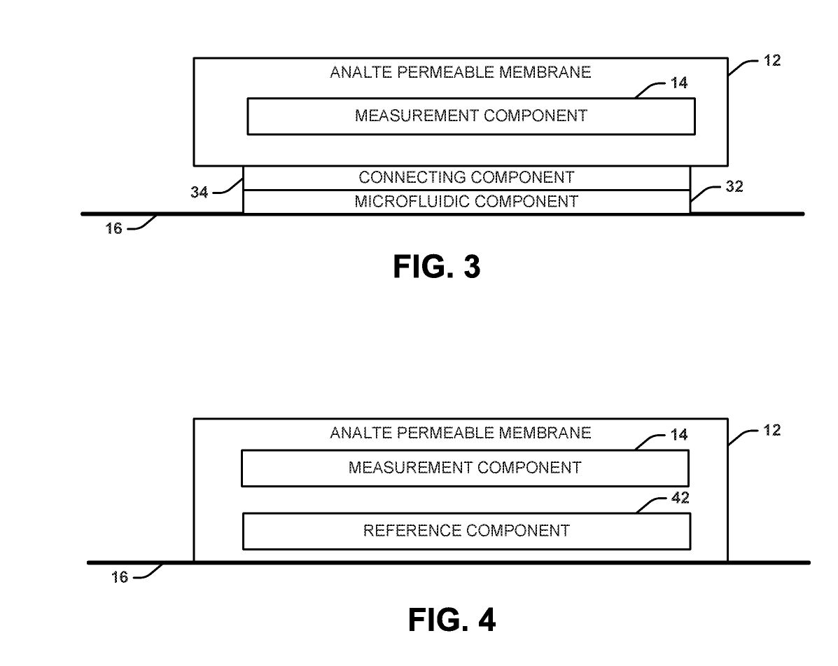

FIG. 3 illustrates a system that can be used to harvest the analyte from the chemically-active surface 16. The system can include a microfluidic component that can be configured to obtain a sample from the chemically-active surface 16. The sample can include the analyte (but need not include the analyte). The system can also include a connecting component that can be configured to allow the sample to interact with the analyte-permeable membrane 12 to facilitate diffusion of the analyte into the sensor for interaction with at least a portion of the measurement component 14.

FIG. 4 illustrates a sensor with a reference component 42 encapsulated within the analyte-permeable membrane. The reference component 42 can either not undergo the change or undergo a known change in the presence of the analyte. The reference system can be used to provide a comparison with regard to the detectable change of the property of the measurement component.

### IV. Methods

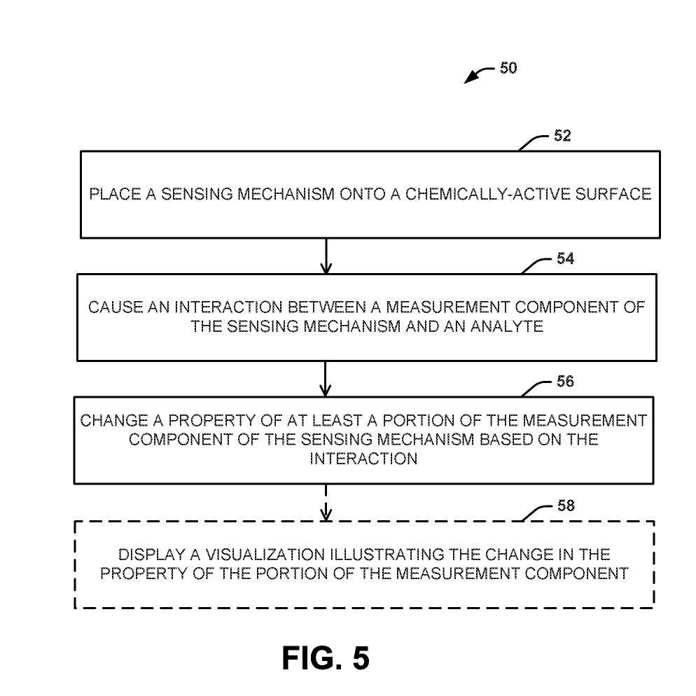

Another aspect of the present disclosure can include a method 50 (FIG. 5) for optochemical imaging of a chemically active surface. In some instances, the method 50 can be executed using the sensor shown in FIG. 1 and described above. One of the main advantages of such optochemical imaging is that the ability to acquire a chemical image of an entire region of interest instantaneously. By using optochemical imaging, the method 50 can eliminate distortion of the concentration field.

The method 50 can generally include the steps of placing a sensing mechanism onto a chemically active surface (Step 52); causing an interaction between a measurement component of the sensing mechanism and an analyte (Step 54); and changing a property of at least a portion of the measurement component of the sensing mechanism based on the interaction (Step 56). Optionally, the method 50 can also include displaying a visualization illustrating the change in the property of the portion of the measurement component (Step 58). The method 50 is illustrated as process flow diagram with flowchart illustrations. For purposes of simplicity, the method 50 is shown and described as being executed serially; however, it is to be understood and appreciated that the present disclosure is not limited by the illustrated order as some steps could occur in different orders and/or concurrently with other steps shown and described herein. Moreover, not all illustrated aspects may be required to implement the method 50.

At Step 52, a sensing mechanism (e.g., analyte permeable membrane 12 and measurement component 14) can be placed onto a chemically-active surface (e.g., chemically-active surface 16). The sensing mechanism can include an analyte permeable membrane coupled to a measurement component. As an example, at least a portion of the measurement component can be housed within the analyte-permeable membrane. The analyte-permeable membrane can be selectively permeable to the analyte while blocking various contaminants from entering. As an example, the analyte-permeable membrane can include one or more hydrogels, while the measurement component can include a component that changes an optical property (like color) in the presence of the analyte, like one or more optode beads or one or more optode membranes. For example, a plurality of optode beads can be dispersed within the analyte-permeable membrane.

In some instances, the analyte-permeable membrane can be secured to the chemically-active surface. For example, the securing can be accomplished by at least a portion of the analyte-permeable surface including a material that facilitates attachment to the chemically-active surface to restrict unwanted movement of the sensor on the chemically-active surface. In other instances, the securing can be accomplished by suction or another property.

At Step 54, the measurement component of the sensing mechanism can interact with an analyte. For example, the interaction can occur upon the analyte diffusing through the analyte-permeable membrane. Indeed, the interaction can be instantaneous (or within microseconds from the analyte diffusing through the analyte-permeable membrane). At Step 56, a property of at least a portion of the measurement component of the sensing mechanism can be changed based on the interaction. For example, the change of the property can be at least one of an electrochemical change, a fluorescence change, a luminescence change, a change in absorption, a conductometric change, and/or a coulometric change.

The change in the property can be correlated to a property or a presence of the analyte. For example, a color of at least a portion of the measurement component can change based on the interaction, and the amount of color change can correlate to the property or the presence of the analyte. The sensor can be calibrated according to a known amount of change. In some instances, the change can be detected based on a comparison between the at least the portion of the measurement component and a reference sensor (which, in some instances, can be within the analyte-permeable membrane) (e.g., reference component 42).

Optionally, at Step 58, visualization can be displayed on a display illustrating the change in the property of the portion of the measurement component. Alternatively, the visualization can illustrate the calibrated property or presence of the analyte. The visualization can be visual, but also may be audio. In other words, the display can be any mechanism configured to communicate an indication related to the change to an end user. The display can be linked to a computing device that includes a non-transitory memory and a processor. The computing device can conduct post-processing of data recorded by the sensor to determine properties of the visualization. For example, the post-processing can include the calibration and/or the comparison to the reference sensor.

### V. Experimental

The following example is for the purpose of illustration only and is not intended to limit the scope of the appended claims.

### Example 1

This example illustrates experiments using optochemical imaging for the visualization of pH maps in a dynamic system where a microscopic pore acts as a source of acid or base. The pore can be thought of as mimicking a biological pore or other small source. Utilizing the optode-bead based chemical imaging approach with pH sensitive beads enables pH propagation of the acid or base coming from the pore to be imaged. Results of these experiments are presented below and show that such optochemical imaging can provide a unique solution that can be extended to applications where current techniques are limited due to extraneous scanning time or non-specific uptake of the measurement probes.

### Methods

### Materials

To make the cocktail for the preparation of the optode microbeads 9-(diethylamino)-5-[(2-octyldecyl)imino]benzo[a]-phenoxazine (hydrogen ion selective chromoionophore III), Bis[(12-crown-4)methyl]-2-dodecyl-2-methylmalonate (bis(12-crown-4)), sodium tetrakis[3,5-bis(1,1,1,3,3,3-hexafluoro-2-methoxy-2-propyl)phenyl]borate (NaHFPB), bis(2-ethylhexyl)sebacate (BENS), poly(vinyl chloride) (PVC) were purchased from Sigma-Aldrich (St. Louis, Mo., USA). Type 1 agarose was used for all membranes (Sigma-Aldrich). Agar membranes were prepared from 0.0001 M phosphate buffered saline, PBS, with pH 7.4 at 25° C. containing 0.138M NaCl and 0.0027M KCl. Deionized water (specific resistance >18.2 MΩ cm) by a Milli-Q water system (Millipore Corp., Bedford, Mass., USA) was used in all solutions.

### Apparatus

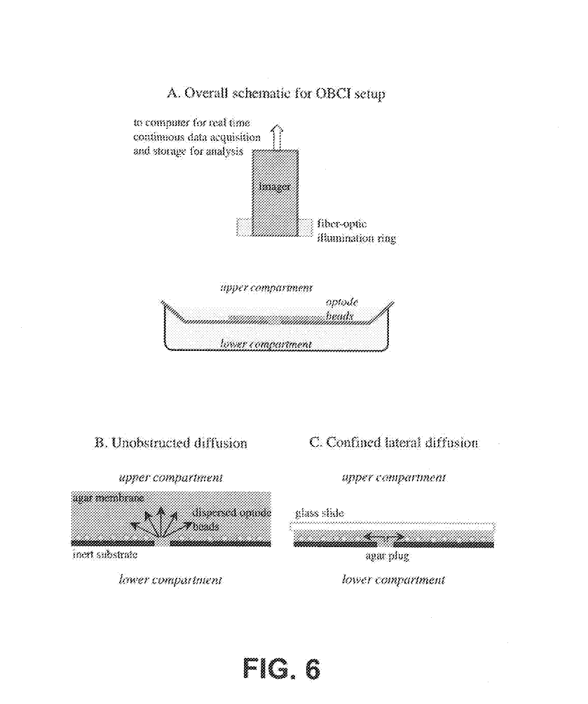

The overall experimental setup is shown schematically in FIG. 6A. Reflectance color images were acquired from above the dish where pH propagation was occurring using a color digital microscope camera (CFW-1012C, Scion Corporation, USA) and ImageJ software (NIH, Bethesda, Md., USA). A circular microscope light was attached to the camera and used as a ring shaped illumination source throughout experiments (Imagelite Model 20, Stokeryale, USA). This arrangement provided uniform illumination over the entire 2 mm2 ROI. Mass transport is shown schematically for 3D hemi-spherical diffusion in Panel B and 2D cylindrical diffusion in panel C. Acid/base diffusion is dynamically imaged with optode microbeads as shown in FIG. 6 in each panel. A polystyrene weigh dish (41×32×8 mm, Fisher Scientific, Waltham, Mass., USA) was used as an inert substrate in diffusion experiments. Agar membranes containing immobilized, dispersed optode beads were placed on the upper surface of the weigh dish. The dish was used also as the upper reservoir. A small micropore was made across the weight dish and filled with agar to form a plug. This pore was used as the microscopic source of the acid or base reagent diffusing from the lower compartment into the upper compartment where imaging took place. The weigh dish was fixed on top of a plastic petri dish (Falcon, 60×15 mm style, Becton Dickinson, Franklin Lakes, N.J., USA), which acted as the lower reservoir containing the buffer whose pH would propagate through the pore.

### Preparation of Microscopic Optode Beads Dispersed in Agar Membrane and Calibration

pH sensitive optode beads 1-3 μm in diameter were made using the spray-dry method described previously by Tohda et al., Micro-miniature Autonomous Optical Sensor Array for Monitoring Ions and Metabolites 1: Design, Fabrication, and Data Analysis. Analytical Sciences. 2006; 22:383-388 (incorporated by reference herein in its entirety). Small loose aggregates were also spontaneously formed from some individual beads. The prepared optode particles were manually dispersed on a glass slide using a pulled glass capillary tip. A second glass slide was pressed to the first slide, to disrupt the aggregates and for further dispersion of the beads by static charges. The slides were separated and two pieces of aluminum foil, 7 μm thick, were placed at the edges of the slides to act as spacers. The two slides were then clamped together using small binder clips placed over the pieces of foil. One of the open ends of the clamped structure was placed in warm, aqueous 1 wt % agar and the liquid gel layer was wicked between the slides with pH sensitive optode beads dispersed throughout by capillary action. (It is noted that for some applications such as in cellular studies aggregates may need to be more perfectly dispersed than what was necessary in this work).

The 7 μm membrane with dispersed optode beads was soaked in PBS for 30 min. The beads were then exposed to PBS solutions with adjusted pH values between 5.0 to 8.0 in 0.5 pH increments. Solutions were made by adjusting 0.1 M PBS with HCl (0.01 M) and KOH (0.01 M) stock solutions, respectively. A pH glass electrode was used to ensure accurate pH values (Accumet 925 pH meter, Fisher Scientific, USA). The calibration was performed by first going in the basic direction of the pH scale from PBS (pH ˜7.36) to 7.5 and 8.0, and then in the acidic direction in 0.5 pH units to pH 5.0. The calibration was then repeated from acidic to alkaline direction. The membrane was exposed to the respective solution for 30 minutes and images were taken approximately 1 minute intervals determine color response and response time. Images were acquired using the Scion microscope camera described above.

Preparation of the Substrate with a Pore Filled with an Agar Plug

A pore in the polystyrene weigh dish was formed by placing a hot soldering iron near a needle tip (Talon American, Stamford, Conn., USA) and placing the hot needle tip perpendicular to the polystyrene substrate. A small pore through the substrate (in the range of 150 to 210 μm in diameter in this work) was formed. 1 wt % agar was made in 0.01 M PBS diluted four times, adjusted to pH 3.5 or 8.5. The pH of the solution was adjusted with HCl or KOH. The substrate was placed upside down approximately 10 cm above simmering DI water. A drop of agar was placed on the substrate covering the source and was allowed to sit above the hot water vapor for 10 min to fill the plug with agar.

### Preparation of Agar Membranes for Immobilizing Dispersed Optode Beads

For lateral diffusion experiments a 7 μm agar membrane with dispersed beads was prepared as described above and then a slide was placed on top. For hemi-spherical diffusion experiments the slide was not used. A thicker, 100 μm agar membrane using a 100 μm thick spacer (microscope cover slip, Fisher Scientific) was prepared, to immobilize the beads at the substrate. The beads were dispersed as described above. The agar membranes do not limit the rate of acid/base mass transport because small ions diffuse across the pores of agar essentially like in free buffer.

### Experimental Setup for Mass Transport and OBCI Measurements in Acidic and Basic Direction

To visualize the propagation of acidic pH 1×10-4 M PBS was adjusted to pH 3.5 for the lower reservoir and pH 7.5 for the upper reservoir. The optode-bead-containing agar membrane was placed flush with the substrate over the agar plug (FIG. 6C) in the upper reservoir. A glass slide was used above the membrane during lateral diffusion experiments with a 1 g weight was placed on the top corner of the glass slide covering the membrane, outside of the ROI, to hold it in place. For diffusion of basic solution a 1×10−4 M PBS solution was adjusted to pH 8.5 for the lower reservoir and pH 4.5 for the upper reservoir. The membranes were treated as described for acid diffusion.

### Image Analysis for Calibration

ImageJ was used to measure red, green, and blue, RGB, intensities at 10 different regions where beads were found in each image. To account for ambient lighting variations in image acquisition, each RGB value was normalized using Pythagorean normalization.

### Image Analysis for Visualization of the Mass Transport Process

The scion microscope camera and ImageJ software were used to acquire images of the dispersed beads immobilized on top of the substrate. Images were acquired in 30 second intervals throughout the length of each experiment.

For each acquired image, the end goal is to generate a concentration map using the information of the color of the beads. This requires a multi-step process which includes 1) extraction of data by thresholding, 2) Delaunay triangulation, 3) color averaging using circular symmetry, and 4) pixel normalization.

Matlab was used for image processing. To obtain data with better temporal continuity, linear interpolation in time was performed on consecutive images to obtain data for 10 second intervals rather than the acquired 30 second intervals.

In order to extract color data from the beads from each image a thresholding scheme was developed to obtain a mask of the image for beads. This would allow analysis using the beads' color information, and utilize this information to fill in the pixels where no beads were placed. The mask included beads (data) and excluded the white substrate. The resultant was a mask of the image consisting of logical variables, where pixels which represented beads were displayed as white=1, and background/substrate displayed as black=0. This map was used for Delaunay triangulation for each image in the same experiment.

To produce a color at each pixel of the image, the color information of each bead was required from the unprocessed images. Using the mask generated by thresholding, each image was processed in Matlab using the GridData function. A Delaunay triangulation was done as an interpolation method to fill in the points where no data was collected and to resolve data from discrete points. The Delaunay triangulation maximizes the minimum angle of all angles of the triangles to avoid skinny triangles. The GridData function provided a Delaunay triangulation for each image using only bead data corresponding to the mask. Each image was first decomposed to three stacks, a Red, Green and Blue stack, respectively. The triangulation was calculated for each of these stacks. The stacks were then compiled once again to produce a color image.

The Delaunay triangulation provides information at most pixels based on data from beads. However, the result shows sharp changes at the vertices of the triangles made by the interpolation function. In order to smooth the image, circular symmetry around the source was assumed around a circular source. Color-averaged rings were then calculated growing outward from the source. Each ring included an average color of its own diameter, 5 pixels wide and also the adjacent outer 5-pixel ring and inner 5-pixel ring, thus creating a 5 pixel ring with 15-pixel radially averaged information. These rings began at the source and were extended throughout the entire image.

### Results

Optode-Based Bead Chemical Imaging of pH Propagation at an Insert Substrate from a Micropore

The propagation of acid or base from a source cannot be described as simple diffusion of H+ or OH− ions: diffusion and titration occur simultaneously at every position in the concentration field, which also implies that both ions diffuse in the same time towards each other at both sides of the boundary between acidic and basic pH. Additionally, the ion product of water must hold at every point in space at all times. This tightly links the movement of H+ and OH− ions everywhere. Buffer capacity also has its own field and local titration depends on this, plus the actual pH at the given point in space. Therefore the loci (typically, a surface) of neutral pH propagate in a more complicated way than what could be expected for simple ion diffusion, since it depends on both the actual pH and buffer capacity fields. This makes it difficult to predict the evolution of pH fields without actually visualizing them in experiments. A somewhat analogous problem would be diffusion of an ion in a solution where its chelator is also present.

pH propagation from a single pore (in the range of 150-210 μm in different experiments) at an inert substrate was visualized under different conditions. Diffusion into an open solution space from the pore above the substrate (FIG. 6A) results in a 3D hemi-spherical diffusion pattern. By mounting a transparent inert cover above the substrate at a distance that is much shorter than the dimensions of the region of interest, ROI (FIG. 6B), 2D lateral diffusion with circular symmetry can be visualized. Similar transport patterns cannot be studied with microelectrode scanning since the narrow diffusion layer (7 μm in this work) cannot be accessed by an electrode. The evolution of pH fields above a 2-mm² area is visualized here. ROIs of similar size are often used in scanning probe techniques, in studies on cell clusters and other applications.

To visualize propagation of acid or base pH-sensitive optode microbeads (1-3 μm in size) are dispersed on top of the substrate. A sparse dispersion is made (average distance between nearest beads: 50-100 μm) in order to minimize obstructions to the propagating concentration fields. Many beads were distributed also in aggregates which were small enough relative to the size of the pore source and the dimensions of the ROI, to provide with a pH map of sufficient resolution. Further, in this paper though aggregates existed, we use only the term “optode microbeads” since they are the probes that actually respond to pH including in the aggregates.

Interpolation of color between the beads and radial symmetry of the diffusion process around the pore in both the 3D and the 2D diffusion schemes were used for image processing to obtain color at each pixel of a snapshot where there are no beads. Pixel colors can be transformed into a pH field at each time point using pre- or post-calibration of the beads.

### Color Response Analysis

The red, green and blue, RGB, reflectance intensity values obtained at pixels where optode beads were located in the images can be used in various ways to quantitatively represent the color information that is linked to pH where a bead is located.

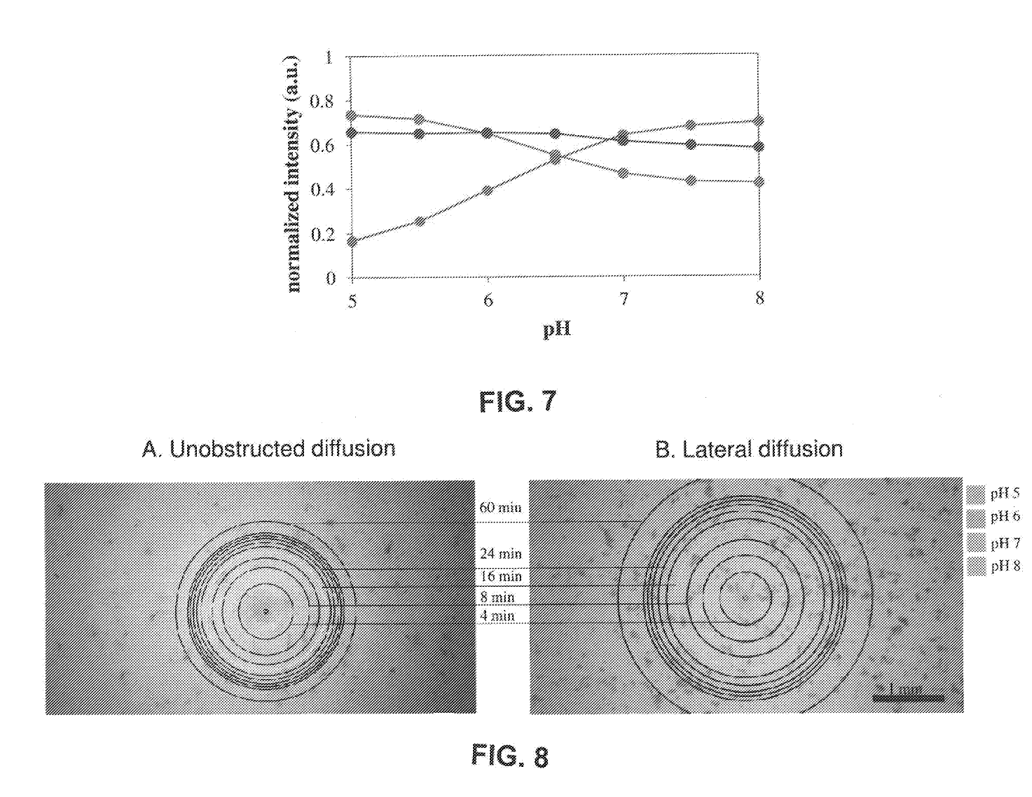

The beads respond to pH with gradual color change from blue to orange as the pH changes from 5 to 8, sufficient to map pH propagation in this work. A calibration is shown in FIG. 7 after Pythagorean normalization of the data. The sensitivity of red color intensity, R, is the greatest. Blue intensity is about half as sensitive as red. The response in green color to pH is relatively flat, which could allow it to be used as internal reference. The greatest rate of change is around pH 6.5, below neutral pH with a resolution of about 0.07 pH unit. Therefore the grayish green color at pH 6.5 is used in this work to track pH propagation, though the loci of pH 6.5 are slightly displaced relative to the loci of neutral pH.

Theoretically, any of the three color components could be used for pH calibration. However, it is advantageous to normalize the RGB values before data analysis. This is to avoid interference from eventual variations in the intensity of the light source or sensitivity of the detector. To avoid also potential interference from spectral variations in the illumination and/or detector, the RGB values could be further normalized to a color standard area such as a white reference. This, however, was not necessary in these experiments due to the stable light source and camera used.

The common method of RGB normalization is normalization to the sum of the RGB values. This transforms the RGB values such that they always lie between 0 and 1. However the absolute value (length) of the corresponding 3D vector [R, G, B] will also vary between 0 and 1 depending on the actual color seen.

In order to be able to use vector analysis for color the measured intensity of each color component was divided by the square root of the sum of squares:

X_{Pn}=X/sqrt(R²+G²+B²),

where X is R, G, or B and Pn stands for Pythagorean normalization.

As opposed to the most common method of normalization to the sum of the color components, Pythagorean normalization always adjusts the RGB vector to unit absolute value, and thus the actual composite color can be perceived as the direction of a vector of unit length in a 3D coordinate system. The color vector defined this way will always end at a point on the positive eighth of the surface of a unit sphere in the normalized RGB coordinate system. Since the response of an optode system is color, the intensity information is not needed, which is why a vector of unit length is sufficient for calibration and measurement. (We note that the “hue” variable is also often used to quantify color, which is especially useful when there is significant background. However in this work there was very little background in the RGB values.)

The color information that is obtained with a regular RGB camera is encoded in 3 values. After normalization only 2 independent variables remain. Thus, for example RPn, or BPn, or both could be used for data analysis. The ratio of these values is also useful, which simplifies the use of calibration since only one value's dependence on pH needs to be considered that could be potentially more sensitive than either value alone. However this ratio value will not be limited to the 0-1 range: it will not be a “bound” variable.

### Dynamic Color Distributions of Dispersed Optode Beads During Acid and Base Propagation

In the experiments shown in FIG. 8, the pH was 8.5 in the lower compartment and the pH was 4.5 in the upper compartment. Both solutions were 10-4 M PBS whose pH was adjusted to the respective values. Hemi-spherical (A, left panel) and lateral (B. right panel) propagation of base at multiple time points are shown in FIG. 8. The images illustrate the spreading of alkaline pH from the pore at the surface. Similar images have been obtained using an acidic source compartment, visualizing the propagation of acid pH (not shown). The spreading of orange color from the pore represents the outward movement of alkaline pH, while the retracting blue color represents progressive over-titration of the originally present acidic solution. The intermediate color between blue and orange is grayish green. The green circle in both panels shows a front of about pH 6.5 (from the calibration in FIG. 7) at the time the image shown was acquired. The black circles indicate the spreading of this pH 6.5 front over time. Therefore they do not exactly coincide with the circle of neutral pH (not shown) but they indicate the dynamics of the process correctly.

In the experiments where the spreading of acid pH into an alkaline compartment was visualized similar trends were observed (not shown). Compared to the results shown in FIG. 8, acid propagation was faster than the propagation of base. At 25° C., the respective diffusion coefficients are DH+=9.31×10−5 cm2/s [26], and DOH−=5.27×10−5 cm2/s. Further, the pH of the strongly acidic reagent used was 3.5, and that of the target compartment, 8.5, was mildly basic. These circumstances rationalize the observation that acid propagation was seen in both cases to be faster than base propagation.

### Evolution of Continuous Color Maps Over Time

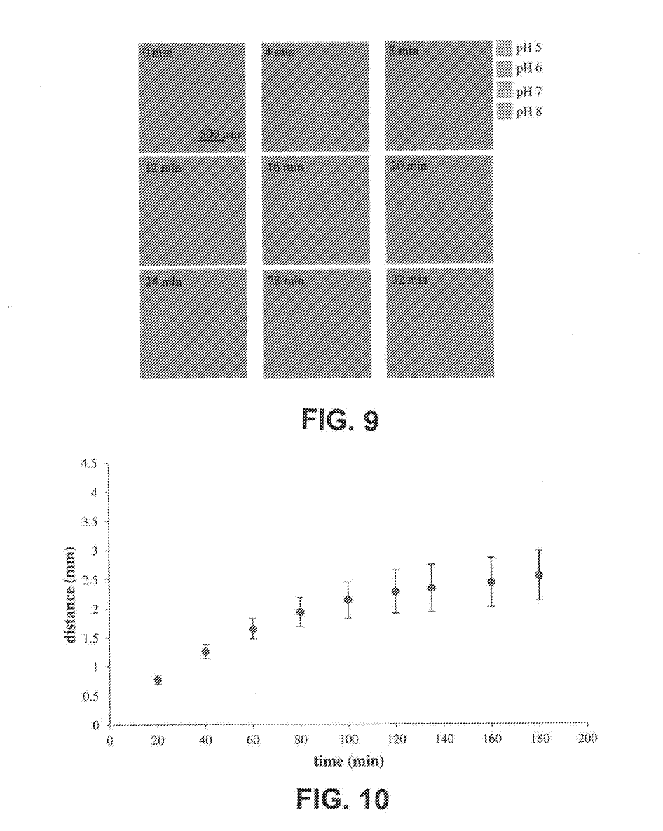

FIG. 9 shows continuous color maps developing over time in a lateral diffusion experiment where hydroxyl ions are entering the upper compartment from the pore and spread in 2D. The continuous maps have been obtained after image processing. In obtaining true continuous maps, two frequencies of interest are taken into account—temporal and spatial. The successive images represent color coded pH fields. In FIG. 10, the evolution of the distance of the locus of pH 6.5, corresponding to respective circles in FIG. 8 is plotted versus time. It is noted that the information contained in FIG. 10 could not be obtained for theoretical considerations, but can be obtained with optode bead-based chemical imaging.

From the above description, those skilled in the art will perceive improvements, changes and modifications. Such improvements, changes and modifications are within the skill of one in the art and are intended to be covered by the appended claims. All patents, patent applications, and publication cited herein are incorporated by reference in their entirety.

The following is claimed:

1. A system comprising:
an analyte-permeable membrane configured to prevent diffusion of outside contaminates into the system, the analyte permeable membrane comprising:
a first surface; and
a second surface opposed to the first surface configured to contact a chemically-active surface to permit diffusion of an analyte into the system from the chemically-active surface; and
a measurement component coupled to the analyte-permeable membrane and configured to interact with the analyte,
wherein the interaction between the analyte and the measurement component causes a detectable change of a property of the measurement component.

2. The system of claim 1 wherein the analyte-permeable membrane comprises a thickness from 10 mm to 500 mm.

3. The system of claim 1, wherein the measurement component comprises an optode membrane.

4. The system of claim 1, wherein the measurement component comprises a plurality of optode beads dispersed within at least a portion of the analyte-permeable membrane.

5. The system of claim 1, wherein at least a portion of the second surface comprises an adhesive surface,
wherein the adhesive surface is configured to secure the system to a location on the chemically-active surface.

6. The system of claim 1, further comprising:
a microfluidic component configured to obtain a sample comprising the analyte; and
a connecting component configured to allow the sample to interact with the analyte-permeable membrane to facilitate the diffusion of the analyte into the system.

7. The system of claim 1, wherein the analyte-permeable membrane comprises a hydrogel membrane.

8. The system of claim 1, further comprising a reference system configured to provide a comparison with regard to the detectable change of the property of the measurement component.

9. The system of claim 1, further comprising an imaging system configured to facilitate detection of the detectable change of the property of the measurement component.

10. The system of claim 9, wherein the imaging system comprises an illumination source, a transducer, a material for transmitting light, and a power source.

11. The system of claim 10, wherein the imaging system comprises a mobile device to display a visualization illustrating the detectable change of the property of the measurement component.

12. The system of claim 10, wherein the material for transmitting light comprises a fiber optic cable, the illumination source comprises a light emitting diode and the transducer comprises at least one photodiode.

13. The system of claim 10, wherein at least one of the illumination source comprises an organic light emitting diode (LED) and the power source comprises an Energy Harvesting Device (EHD).

14. The system of claim 1, wherein the change of the property comprises at least one of an electrochemical change, a fluorescence change, a luminescence change, a change in absorption, a conductometric change, and a coulometric change.

15. The system of claim 1, further comprising a mechanism configured to communicate an indication related to the detectable change of the property of the measurement component to an end user.

16. The system of claim 14 wherein the mechanism comprises at least one of a local active display and a remote monitoring station.

17. A method comprising:
placing a sensing mechanism onto a chemically-active surface, wherein the sensing mechanism comprises an analyte-permeable membrane configured to prevent diffusion of outside contaminates into the system, the analyte permeable membrane while permitting diffusion of an analyte into the sensing mechanism and a measurement component coupled to the analyte-permeable membrane and configured to interact with the analyte; and
changing of a property of the measurement component based on an interaction between the measurement component and the analyte,
wherein the change of the property of the measurement component correlates to a property of the analyte.

18. The method of claim 17, wherein the measurement component comprises a plurality of optode beads dispersed within at least a portion of the analyte-permeable membrane or an optode membrane.

19. The method of claim 17, further comprising displaying, by a system comprising a processor, a visualization illustrating at least one of the detectable change of the property of the measurement component or the correlated property of the analyte.

20. The method of claim 17, further securing the sensing mechanism to a location on the chemically-active surface.
